(19) United States
(12) Patent Application Publication
(10) Pub. No.: US 2019/0316921 A1
(43) Pub. Date: Oct. 17, 2019

(54) NAVIGATION DEVICE AND DISPLAY CONTROL METHOD

(71) Applicant: MITSUBISHI ELECTRIC CORPORATION, Tokyo (JP)

(72) Inventor: Masanobu OSAWA, Tokyo (JP)

(73) Assignee: MITSUBISHI ELECTRIC CORPORATION, Tokyo (JP)

(21) Appl. No.: 16/348,000

(22) PCT Filed: Jan. 6, 2017
(86) PCT No.: PCT/JP2017/000246

§ 371 Date: May 7, 2019

(51) Int. Cl. G01C 21/34; G06Q 30/06; G06Q 10/06; G06Q 10/02

(52) U.S. Cl. CPC G01C 21/3438; G06Q 10/02; G06Q 10/06311; G06Q 30/0645

(57) ABSTRACT

Disclosed is a navigation device mounted in a vehicle shared through person-to-person car sharing, the navigation device including: storage units for storing pieces of personal information; a reservation information acquiring unit for acquiring a scheduled rental date and time of the vehicle from a first server device that manages the person-to-person car sharing; and a concealment control unit for concealing the pieces of personal information stored in the storage units when the current date and time becomes identical to the scheduled rental date and time.

### TECHNICAL FIELD

The present invention relates to a vehicle-mounted navigation device and a display control method for a display device mounted in a vehicle.

### BACKGROUND ART

Conventionally, there has been provided a service, which is so-called “car sharing” or “car rental”, for providing sharing of a vehicle owned by a specific business operator by renting out the vehicle to multiple users. A navigation device may be mounted in a vehicle shared through car sharing or car rental. Pieces of information (referred to as “personal information” hereafter) showing the address, the name, an action history, interest, tastes or friends and acquaintances, etc. of each user may be stored in the navigation device. In Patent Literatures 1 and 2, a technique for preventing a leakage of personal information in a navigation device used for a vehicle shared through car sharing or car rental is disclosed.

In a car sharing system of Patent Literature 1, user specific ID information is recorded in an IC card that is issued to each user by a car sharing system management company. A navigation device of Patent Literature 1 compares the ID information about a user who used the vehicle the last time and the ID information about another user who uses the vehicle this time, and deletes the personal information when the pieces of ID information do not match each other.

A navigation device of Patent Literature 2 deletes the personal information when the vehicle falls within a predetermined region from a vehicle registered point (a service office or the like of a business operator that provides car rental services).

### CITATION LIST

### Patent Literature

Patent Literature 1: Japanese Unexamined Patent Application Publication No. 2013-44708

Patent Literature 2: Japanese Unexamined Patent Application Publication No. 2010-145330

### SUMMARY OF INVENTION

### Technical Problem

In recent years, there has been provided a service, which is so-called “person-to-person car sharing”, for providing sharing of a vehicle owned by a specific user by renting out the vehicle to another user. A navigation device may be mounted in a vehicle shared through the person-to-person car sharing. In the navigation device, personal information about the owner of the vehicle is stored usually.

Both of the conventional navigation devices shown in Patent Literatures 1 and 2 prevent the leakage of the personal information by simply deleting the personal information. If such a conventional navigation device is mounted in a vehicle shared through person-to-person car sharing, and a user of the vehicle uses the vehicle, the personal information about the owner of the vehicle is deleted. Thus, a problem is that when the owner of the vehicle uses the returned vehicle, the owner of the vehicle cannot use a function that the navigation device has and that uses the personal information about himself or herself.

The present invention is made in order to solve the above-mentioned problem, and it is therefore an object of the present invention to provide a technique for, in a navigation device mounted in a vehicle shared through person-to-person car sharing, preventing any personal information about the owner of the vehicle from leaking out when the vehicle is being rented out, while ensuring a state in which the owner of the vehicle can use a function using personal information about himself or herself after the vehicle is returned.

### Solution to Problem

According to the present invention, there is provided a navigation device mounted in a vehicle shared through person-to-person car sharing, the navigation device including: a storage unit for storing personal information; a reservation information acquiring unit for acquiring a scheduled rental date and time of the vehicle from a server device that manages the person-to-person car sharing; and a concealment control unit for concealing the personal information stored in the storage unit when the current date and time becomes identical to the scheduled rental date and time.

### Advantageous Effects of Invention

According to the present invention, in the navigation device mounted in the vehicle shared through the person-to-person car sharing, any personal information about the owner of the vehicle can be prevented from leaking out when the vehicle is being rented out, while a state in which the owner of the vehicle can use a function based on personal information about himself or herself is ensured after the vehicle is returned.

### BRIEF DESCRIPTION OF DRAWINGS

FIG. 1 is a functional block diagram showing a main part of a person-to-person car sharing system including a navigation device according to Embodiment 1 of the present invention;

FIG. 2A is a hardware block diagram showing a main part of a first server device according to Embodiment 1 of the present invention;

FIG. 2B is another hardware block diagram showing the main part of the first server device according to Embodiment 1 of the present invention;

FIG. 3A is a hardware block diagram showing a main part of the navigation device according to Embodiment 1 of the present invention;

FIG. 3B is another hardware block diagram showing the main part of the navigation device according to Embodiment 1 of the present invention;

FIG. 4A is a flowchart showing the operation of the navigation device according to Embodiment 1 of the present invention;

FIG. 4B is a flowchart showing the operation of the navigation device according to Embodiment 1 of the present invention;

FIG. 5A is an explanatory drawing showing an example of a menu screen that the navigation device according to Embodiment 1 of the present invention causes a display device to display in a state in which pieces of personal information are not concealed;

FIG. 5B is an explanatory drawing showing an example of a menu screen that the navigation device according to Embodiment 1 of the present invention causes the display device to display in a state in which the pieces of personal information are concealed;

FIG. 6 is a functional block diagram showing a main part of a person-to-person car sharing system including the navigation system according to Embodiment 1 of the present invention;

FIG. 7 is a functional block diagram showing a main part of a person-to-person car sharing system including a navigation device according to Embodiment 2 of the present invention;

FIG. 8A is a flowchart showing the operation of the navigation device according to Embodiment 2 of the present invention; and

FIG. 8B is a flowchart showing the operation of the navigation device according to Embodiment 2 of the present invention.

### DESCRIPTION OF EMBODIMENTS

Hereafter, in order to explain this invention in greater detail, embodiments of the present invention will be described with reference to the accompanying drawings.

### Embodiment 1

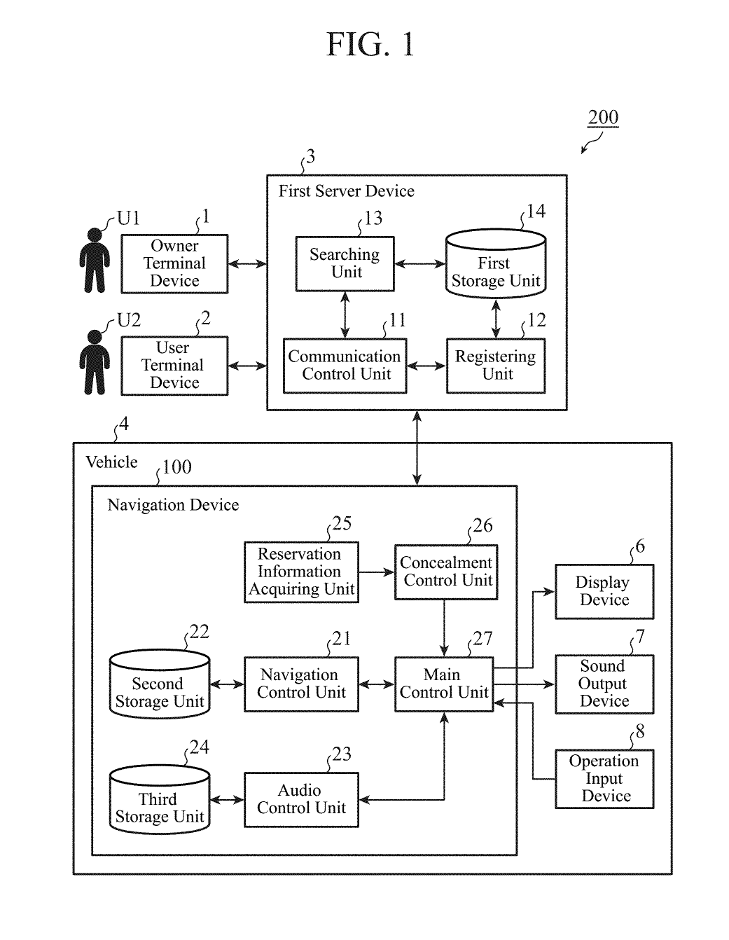

FIG. 1 is a functional block diagram showing a main part of a person-to-person car sharing system including a navigation device according to Embodiment 1 of the present invention. Referring to FIG. 1, the navigation device 100 of Embodiment 1, and the person-to-person car sharing system 200 including this navigation device 100 will be explained.

An owner terminal device 1 is an information terminal device owned by a vehicle owner in person-to-person car sharing. The owner terminal device 1 is constituted by, for example, a mobile information terminal, such as a smartphone or a tablet terminal, or a PC (Personal Computer). The owner terminal device 1 freely communicates with a first server device 3 via a not-illustrated network.

A user terminal device 2 is an information terminal device owned by a vehicle user in the person-to-person car sharing. The user terminal device 2 is constituted by, for example, a mobile information terminal, such as a smartphone or a tablet terminal, or a PC. The user terminal device 2 freely communicates with the first server device 3 via a not-illustrated network.

The first server device 3 is used for the management of the person-to-person car sharing. The first server device 3 has a communication control unit 11, a registering unit 12, a searching unit 13, and a first storage unit 14. Further, the first server device 3 has a not-illustrated communication unit, and freely communicates with the owner terminal device 1 and the user terminal device 2 via a not-illustrated network and freely communicates with the navigation device 100 mentioned later. The communication unit is constituted by, for example, a receiver and a transmitter for exclusive use.

A vehicle owner U1 owns a vehicle 4. The owner terminal device 1 receives an input of information about the vehicle 4 (referred to as “vehicle information” hereafter), and an input of information about the vehicle owner U1 (referred to as “owner information” hereafter), and transmits the pieces of information to the first server device 3. The vehicle information shows, for example, a vehicle type of vehicle 4. The owner information shows, for example, the name of the vehicle owner U1 and contact information about the vehicle owner such as an e-mail address. Hereafter, the vehicle information and information transmitted together with the vehicle information, such as the owner information, are generically called “the vehicle information etc.” in some cases.

When the communication unit of the first server device 3 receives the vehicle information etc. from the owner terminal device 1, the communication control unit 11 outputs this vehicle information to the registering unit 12. The registering unit 12 causes the first storage unit 14 to store the vehicle information etc. At this time, the registering unit 12 causes the first storage unit to store the owner information while associating the owner information with the vehicle information.

Pieces of vehicle information about multiple vehicles including the vehicle 4 shown in FIG. 1 are stored in the first storage unit 14. Pieces of owner information about multiple vehicle owners owning the respective multiple vehicles, i.e., multiple vehicle owners including the vehicle owner U1 shown in FIG. 1 are stored in the first storage unit 14.

The user terminal device 2 receives an input of information (referred to as “search condition information” hereafter) showing a search condition for searching through the vehicles corresponding to the pieces of vehicle information etc. stored in the first storage unit 14 for a vehicle usable by a vehicle user U2, and transmits the search condition information to the first server device 3. The search condition information includes, for example, a vehicle type of vehicle that the vehicle user desires to use, an area where the vehicle user desires to use the vehicle, a scheduled start date and time of use of the vehicle, and a scheduled end date and time of use of the vehicle.

When the communication unit of the first server device 3 receives the search condition information from the user terminal device 2, the communication control unit 11 outputs this search condition information to the searching unit 13. The searching unit 13 searches through the vehicles corresponding to the pieces of vehicle information etc. stored in the first storage unit 14 for a vehicle satisfying the search condition shown by the search condition information. The searching unit 13 outputs a search result to the communication control unit 11.

When one or more vehicles are included in the search result outputted by the searching unit 13, the communication control unit 11 controls the communication unit in such a way as to transmit the vehicle information corresponding to each of the one or more vehicles, out of the pieces of vehicle information stored in the first storage unit 14, to the user terminal device 2. In contrast, when no vehicle is included in the search result outputted by the searching unit 13, the communication control unit 11 controls the communication unit in such a way to notify the user terminal device 2 to that effect.

When receiving the vehicle information from the first server device 3, the user terminal device 2 selects a vehicle that the vehicle user U2 desires to use from among the one or more vehicles under an operation performed by the vehicle user. The user terminal device 2 transmits a request for rental of the vehicle selected thereby to the first server device 3.

When the communication unit of the first server device 3 receives the rental request from the user terminal device 2, the communication control unit 11 controls the communication unit in such a way as to output a notification showing that the rental request is made to the owner terminal device 1 of the vehicle owner owning the vehicle corresponding to this rental request. This notification includes a part of the descriptions of the search condition information received from the user terminal device 2 (the area where the vehicle user U2 desires to use the vehicle, the scheduled start date and time of use of the vehicle, and the scheduled end date and time of use of the vehicle).

Concretely, for example, the communication control unit 11 controls the communication unit in such a way as to transmit an e-mail showing a description of the notification to the e-mail address of the vehicle owner shown by the owner information stored in the first storage unit 14. When the vehicle corresponding to the rental request is the vehicle 4 shown in FIG. 1, the communication control unit 11 controls the communication unit in such a way as to transmit the e-mail to the e-mail address of the vehicle owner U1 shown in FIG. 1. The vehicle owner U1 receives the e-mail by using the owner terminal device 1.

When receiving the notification showing that the rental request is made from the first server device 3, the owner terminal device 1 selects whether or not to approve this rental request under an operation performed by the vehicle owner U1, and transmits a selection result to the first server device 3.

When the rental request is approved by the vehicle owner U1, the communication control unit 11 controls the communication unit in such a way as to notify the user terminal device 2 to that effect. As a result, a reservation for rental of the vehicle 4 is finalized. The communication control unit 11 instructs the registering unit 12 to cause the first storage unit 14 to store information about the rental reservation (referred to as “reservation information” hereafter). The registering unit 12 causes the first storage unit to store the reservation information while associating the reservation information with the vehicle information corresponding to the vehicle 4.

Here, the reservation information shows at least both a scheduled rental date and time and a scheduled return date and time of the vehicle 4.

When the rental reservation is finalized, the vehicle owner U1 and the vehicle user U2 set up a scheduled rental point, a scheduled return point, etc. of the vehicle 4 by using communications between the owner terminal device 1 and the user terminal device 2 via the communication control unit 11.

In contrast, when the rental request is not approved by the vehicle owner U1, the communication control unit 11 controls the communication unit in such a way as to notify the user terminal device 2 to that effect.

Each of the above-mentioned processes by the owner terminal device 1 is performed by, for example, application software for exclusive use installed in the owner terminal device 1. Each of the above-mentioned processes by the user terminal device 2 is performed by, for example, application software for exclusive use installed in the user terminal device 2. The setup of the scheduled rental point, the scheduled return point, etc. at the time that the rental reservation is finalized is performed by, for example, using communication functions that the pieces of application software have.

The descriptions of the vehicle information that the owner terminal device 1 transmits to the first server device 3 are not limited to a vehicle type of vehicle 4. For example, the vehicle information can show the model year or the color of the vehicle 4, in addition to the vehicle type of vehicle 4. In this case, the search condition information that the user terminal device 2 transmits to the first server device 3 can include information showing the model year or the color of a vehicle that the vehicle user U2 desires to use.

Further, the descriptions of the owner information that the owner terminal device 1 transmits to the first server device 3 are not limited to the name and the contact information of the vehicle owner U1. For example, the owner information can show the gender or the age of the vehicle owner U1, in addition to the name and the contact information of the vehicle owner U1. In this case, the search condition information that the user terminal device 2 transmits to the first server device 3 can include information showing the gender or the age of the owner of a vehicle that the vehicle user U2 desires to use.

Further, when information (referred to as “rental condition information” hereafter) about rental conditions on the vehicle 4 is inputted, the owner terminal device 1 can transmit this rental condition information, together with the vehicle information and the owner information, to the first server device 3. The rental condition information includes, for example, at least one of an area, a date, and a time zone in/at which the vehicle 4 can be rented out. In this case, the registering unit 12 causes the first storage unit 14 to store the rental condition information while associating the rental condition information with the owner information.

However, the rental condition information that the owner terminal device 1 transmits to the first server device 3 can be one in which some or all of the following items: the area, the date, or the time zone in/at which the vehicle 4 can be rented out are not inputted. More specifically, the setup of the rental condition information is not indispensable, and the rental condition information is set up as appropriate when the vehicle owner U1 desires to restrict the rental conditions.

Further, the descriptions of the rental condition information that the owner terminal device 1 transmits to the first server device 3 are not limited to the area, the date, and the time zone in/at which the vehicle 4 can be rented out. For example, the rental condition information can include the gender or the age of a vehicle user to whom the vehicle 4 can be rented out. In this case, when transmitting the search condition information to the first server device 3, the user terminal device 2 can transmit the search condition information together with information including the gender or the age of the vehicle user U2. The searching unit 13 can include only a vehicle which is included in the vehicles satisfying the search condition shown by the search condition information and as to which the vehicle user U2 satisfies the rental conditions shown by the pieces of rental condition information associated with the pieces of vehicle information corresponding to the vehicles, in the search result.

As an alternative, when transmitting the rental request to the first server device 3, the user terminal device 2 can transmit the rental request together with information including the gender or the age of the vehicle user U2. In this case, when controlling the communication unit in such a way as to output the notification showing that the rental request is made to the owner terminal device 1, the communication control unit 11 can include the gender or the age of the vehicle user U2 in the notification, in addition to including some of the descriptions of the search condition information in the notification.

Further, the setup of the scheduled rental point, the scheduled return point, etc. in the case in which a rental reservation is finalized can be performed using a phone, an e-mail, an SNS (Social Networking Service), or the like, without using the pieces of application software for exclusive use installed in the owner terminal device 1 and the user terminal device 2 (i.e., not via the communication control unit 11).

The vehicle 4 has the navigation device 100. The navigation device 100 is constituted by a vehicle-mounted information terminal provided integrally with the dashboard of the vehicle 4.

Further, the vehicle 4 has a display device 6, a sound output device 7, and an operation input device 8. The display device 6 is constituted by, for example, a display provided integrally with the navigation device 100, such as a liquid crystal display or an organic EL (Electro Luminescence) display. The sound output device 7 is constituted by, for example, a speaker mounted in the vehicle 4. The operation input device 8 is constituted by, for example, a touch sensor provided integrally with the display of the display device 6, hardware switches provided integrally with the navigation device 100, a remote controller provided integrally with or separately from the steering wheel of the vehicle 4, a gesture recognition device that recognizes an input of an operation performed by gesture, a voice recognition device that recognizes an input of an operation performed by voice, or the like.

Hereafter, a main part of the navigation device 100 will be explained. The navigation device 100 has a not-illustrated communication unit, and freely communicates with the first server device 3 via a not-illustrated network. The communication unit of the navigation device 100 is constituted by, for example, a receiver and a transmitter for exclusive use.

A navigation control unit 21 has a function of determining the current position of the vehicle 4 by using GPS signals or the likes received by a not-illustrated GPS (Global Positioning System) receiver. Further, the navigation control unit 21 has a function of, in response to an operation inputted to the operation input device 8, using map data stored in a second storage unit 22 to search for a facility or an address that is a candidate for a destination or a waypoint of the vehicle 4 and search for a travel route from the current position to the destination. In addition, the navigation control unit 21 generates image data used for guidance of a travel route set as a target for guidance. Further, the navigation control unit 21 generates voice data used for guidance of the travel route set as the target for guidance. In addition, the navigation control unit 21 has the same various functions as those adopted in typical car navigation.

The second storage unit 22 stores various pieces of information used in the various functions that the navigation control unit 21 has, in addition to the map data.

An audio control unit 23 has a function of, in response to an operation inputted to the operation input device 8, using pieces of musical piece data stored in a third storage unit 24 to search for a piece of music that is a candidate for a playback target on the basis of the title of the piece of music or an artist name. Further, the audio control unit 23 has a function of playing back the piece of music corresponding to the musical piece data set as the playback target, i.e., a function of outputting the musical piece data to a main control unit 27. In addition, the audio control unit 23 has the same various functions as those adopted in typical car audio.

The third storage unit 24 stores various pieces of information used in the various functions that the audio control unit 23 has, in addition to the pieces of musical piece data.

The main control unit 27 outputs a signal corresponding to an operation inputted to the operation input device 8 to either the navigation control unit 21 or the audio control unit 23. Further, the main control unit 27 causes the display device 6 to display an image corresponding to the image data generated by the navigation control unit 21, and causes the sound output device 7 to output a voice corresponding to the voice data generated by the navigation control unit 21. In addition, the main control unit 27 causes the sound output device 7 to output a sound corresponding to the musical piece data outputted by the audio control unit 23.

Hereafter, the navigation control unit 21 and the audio control unit 23 may be generically and simply called the “control unit.” Further, the second storage unit 22 and the third storage unit 24 may be generically and simply called the “storage unit.”

The storage units 22 and 24 can be shared by the control units 21 and 23 and a control unit (not illustrated) corresponding to another function that the navigation device 100 has. For example, in a case in which the navigation device 100 has a handsfree call function, the storage units 22 and 24 can store information showing an incoming and outgoing call history or the like made by the handsfree call function.

A reservation information acquiring unit 25 acquires the reservation information about the vehicle 4, out of the pieces of reservation information stored in the first storage unit 14 of the first server device 3, by controlling the communication unit of the navigation device 100. The reservation information acquiring unit 25 outputs the reservation information acquired thereby to a concealment control unit 26.

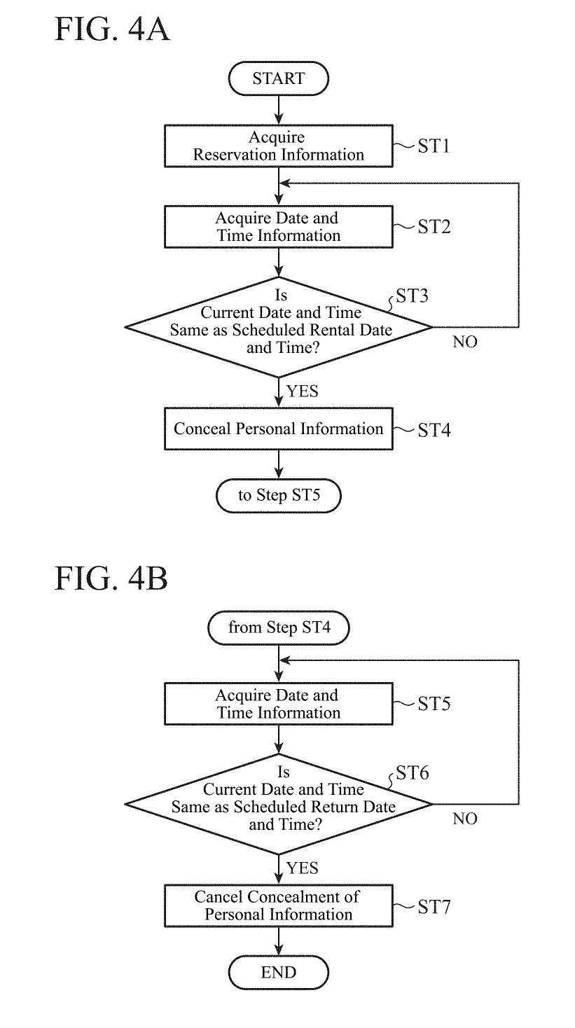

The concealment control unit 26 acquires information (referred to as “date and time information” hereafter) showing the current date and time from, for example, the navigation control unit 21. The concealment control unit 26 determines whether or not the current date and time shown by the date and time information acquired thereby is the same as the scheduled rental date and time of the vehicle 4 that is included in the reservation information inputted from the reservation information acquiring unit 25, by comparing the current date and time and the scheduled rental date and time. When the current date and time becomes the same as the scheduled rental date and time, the concealment control unit 26 conceals the pieces of information stored in the storage units 22 and 24 and showing the address, the name, the action history, the interest, the tastes or the friends and acquaintances, etc. of the vehicle owner U1, i.e., the pieces of personal information. Here, the “concealment” of the pieces of personal information is, for example, to prevent any personal information from being displayed on the display device 6 even though a function of referring to personal information and disclosing the personal information at the time of execution is performed. As an alternative, the concealment of the pieces of personal information is, for example, to disable a function of referring to personal information and disclosing the personal information at the time of execution. Concrete examples of the process of concealing the pieces of personal information will be mentioned later by referring to a flowchart of FIG. 4A.

Further, the concealment control unit 26 determines whether or not the current date and time shown by the date and time information acquired thereby is the same as the scheduled return date and time of the vehicle 4 that is included in the reservation information inputted from the reservation information acquiring unit 25, by comparing the current date and time and the scheduled return date and time. When the current date and time becomes the same as the scheduled return date and time, the concealment control unit 26 cancels the concealment of the pieces of personal information. A concrete example of the process of cancelling the concealment of the pieces of personal information will be mentioned later by referring to a flowchart of FIG. 4B.

Hereafter, a concrete example of the pieces of personal information will be explained.

For example, information showing the name and the position of a facility that the vehicle owner U1 set as a destination or a waypoint in the past, an address that the vehicle owner U1 set as a destination or a waypoint in the past, etc., i.e., so-called “destination history information” is stored in the second storage unit 22. Further, information showing a travel route along which the vehicle owner U1 traveled in the past by using the vehicle 4, etc., i.e., so-called “travel history information” is stored in the second storage unit 22. Because the destination history information and the travel history information are related to the action history of the vehicle owner U1, they are set as pieces of personal information.

Further, for example, there is a case in which the navigation control unit 21 has a function of registering a point showing the home of the vehicle owner U1, a point showing a facility in which the vehicle owner U1 is interested, etc. in advance, to simplify an operation at a time of setting a registered point as a destination or a waypoint. In this case, information showing the registered points, i.e., so-called “registered point information” is stored in the second storage unit 22. Because the registered point information is one that makes it possible to identify the vehicle owner U1, or that shows a taste of the vehicle owner U1, the registered point information is set as personal information.

Further, for example, while pieces of musical piece data are stored in the third storage unit 24, information showing a piece of music that the vehicle owner U1 played back in the past, i.e., so-called “playback history information” is stored in the third storage unit 24. Because the data about the piece of music is information showing a taste of the vehicle owner U1, the musical piece data is set as personal information. Because the playback history information is one that shows a taste of the vehicle owner U1, or that is related to the action history of the vehicle owner U1, the playback history information is set as personal information.

Further, for example, there is a case in which the storage units 22 and 24 are shared by the control units 21 and 23 and another control unit (not illustrated), and the information showing the incoming and outgoing call history or the like made by the handsfree call function is stored in the storage units 22 and 24, as mentioned above. Because the information showing the incoming and outgoing call history is related to either the action history or the friends and acquaintances of the vehicle owner U1, the information is set as personal information.

The types of pieces of information each set as personal information can be preset when the navigation device 100 is produced. As an alternative, the concealment control unit 26 can cause the display device 6 to display pieces of information each of which is a candidate for personal information in a list form, to allow the vehicle owner U1 to select information to be set as personal information from among the pieces of information.

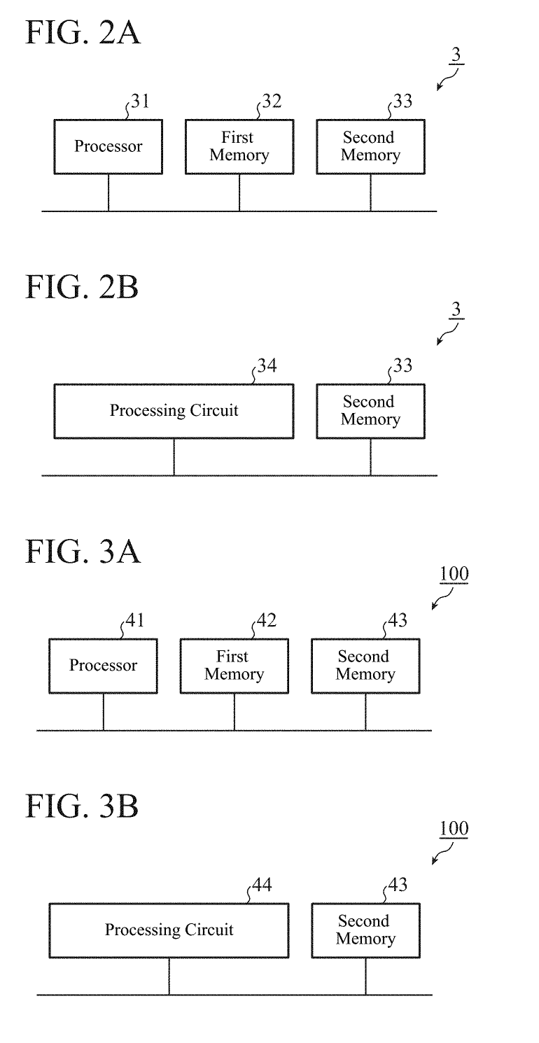

Next, the hardware configuration of a main part of the first server device 3 will be explained by referring to FIG. 2. As shown in FIG. 2A, the first server device 3 is constituted by a computer, and has a processor 31, a first memory 32, and a second memory 33. The first storage unit 14 shown in FIG. 1 is implemented by the second memory 33. A program for causing the computer to operate as the communication control unit 11, the registering unit 12, and the searching unit 13 which are shown in FIG. 1 is stored in the first memory 32. The functions of the communication control unit 11, the registering unit 12, and the searching unit 13 which are shown in FIG. 1 are implemented by the processor 31's reading and execution of the program stored in the first memory 32.

As the processor 31, for example, a CPU (Central Processing Unit), a microprocessor, a microcontroller, a DSP (Digital Signal Processor), or the like is used. As the first memory 32, for example, a semiconductor memory, such as a RAM (Random Access Memory), a ROM (Read Only Memory), a flash memory, an EPROM (Erasable Programmable Read Only Memory), or an EEPROM (Electrically Erasable Programmable Read-Only Memory), is used. As the second memory 33, for example, an HDD (Hard Disk Drive), an SSD (Solid State Drive), or the like is used.

Further, as shown in FIG. 2B, as the first server device 3, a processing circuit 34 for exclusive use can be used instead of the processor 31 and the first memory 32 which are shown in FIG. 2A. The processing circuit 34 is, for example, an ASIC (Application Specific Integrated Circuit), an FPGA (Field-Programmable Gate Array), a system LSI (Large-Scale Integration), or a combination of these circuits.

Each of the functions of the communication control unit 11, the registering unit 12, and the searching unit 13 which are shown in FIG. 1 can be implemented by the processing circuit 34, or the functions of the units can be implemented collectively by the processing circuit 34. Further, some of the functions of the communication control unit 11, the registering unit 12, and the searching unit 13 which are shown in FIG. 1 can be implemented by the processor 31 and the first memory 32 which are shown in FIG. 2A, and remaining functions can be implemented by the processing circuit 34 shown in FIG. 2B.

Next, the hardware configuration of a main part of the navigation device 100 will be explained by referring to FIG. 3. As shown in FIG. 3A, the navigation device 100 is constituted by a computer, and has a processor 41, a first memory 42, and a second memory 43. The second storage unit 22 and the third storage unit 24 which are shown in FIG. 1 are implemented by the second memory 43. A program for causing the computer to operate as the navigation control unit 21, the audio control unit 23, the reservation information acquiring unit 25, the concealment control unit 26, and the main control unit 27 which are shown in FIG. 1 is stored in the first memory 42. The functions of the navigation control unit 21, the audio control unit 23, the reservation information acquiring unit 25, the concealment control unit 26, and the main control unit 27 which are shown in FIG. 1 are implemented by the processor 41's reading and execution of the program stored in the first memory 42.

As the processor 41, for example, a CPU, a microprocessor, a microcontroller, a DSP, or the like is used. As the first memory 32, for example, a semiconductor memory, such as a RAM, a ROM, a flash memory, an EPROM, or an EEPROM, is used. As the second memory 33, for example, an HDD, an SSD, or the like is used.

Further, as shown in FIG. 3B, as the navigation device 100, a processing circuit 44 for exclusive use can be used instead of the processor 41 and the first memory 42 which are shown in FIG. 3A. The processing circuit 44 is, for example, an ASIC, an FPGA, a system LSI, or a combination of these circuits.

Each of the functions of the navigation control unit 21, the audio control unit 23, the reservation information acquiring unit 25, the concealment control unit 26, and the main control unit 27 which are shown in FIG. 1 can be implemented by the processing circuit 44, or the functions of the units can be implemented collectively by the processing circuit 44. Further, some of the functions of the navigation control unit 21, the audio control unit 23, the reservation information acquiring unit 25, the concealment control unit 26, and the main control units 27 which are shown in FIG. 1 can be implemented by the processor 41 and the first memory 42 which are shown in FIG. 3A, and remaining functions can be implemented by the processing circuit 34 shown in FIG. 3B.

Next, the operation of the navigation device 100 will be explained by referring to the flowcharts of FIGS. 4A and 4B, focusing on the process of concealing the pieces of personal information and the process of cancelling the concealment.

First, in step ST1, the reservation information acquiring unit 25 acquires the reservation information about the vehicle 4, out of the pieces of reservation information stored in the first storage unit 14 of the first server device 3, by controlling the communication unit of the navigation device 100. The reservation information acquiring unit 25 outputs the reservation information acquired thereby to the concealment control unit 26.

Then, in step ST2, the concealment control unit 26 acquires the date and time information from, for example, the navigation control unit 21.

Then, in step ST3, the concealment control unit 26 compares the current date and time shown by the date and time information acquired in step ST2 and the scheduled rental date and time of the vehicle 4 that is included in the reservation information inputted, in step ST1, from the reservation information acquiring unit 25. The concealment control unit 26 determines whether or not the current date and time is the same as the scheduled rental date and time on the basis of the comparison.

When it is determined that the current date and time differs from the scheduled rental date and time (“NO” in step ST3), i.e., when the current date and time is earlier than the scheduled rental date and time, the concealment control unit 26 returns to the process of step ST2.

In contrast, when it is determined that the current date and time is the same as the scheduled rental date and time (“YES” in step ST3), the concealment control unit 26, in step ST4, conceals the pieces of personal information stored in the storage units 22 and 24. Hereafter, concrete examples of the process in step ST4 will be explained.

A first concrete example is one in which storage areas of the storage units 22 and 24 are applied. More specifically, in the first concrete example, the second storage unit 22 has a storage area (referred to as a “first storage area” hereafter) to which the navigation control unit 21 refers when a function of disclosing personal information is performed, and another storage area (referred to as a “second storage area” hereafter).

In step ST4, the concealment control unit 26 makes a copy of only the pieces of personal information, out of the pieces of information stored in the first storage area in the second storage unit 22, and causes the second storage area in the second storage unit 22 to store the copy. Then, the concealment control unit 26 deletes only the pieces of personal information, out of the pieces of information stored in the first storage area in the second storage unit 22. As a result, there occurs a state in which the pieces of personal information related to functions performed by the navigation control unit 21 are concealed.

For example, it is assumed that when the destination history information is set as personal information, the concealment control unit 26, instep ST4, performs the process. In this case, when, after step ST4, the vehicle user U2 inputs an operation of causing the navigation device 100 to display a history of facilities or addresses each of which was set as a destination or a waypoint in the past in the navigation device to the operation input device 8, a history that does not include the facilities or the addresses that the vehicle owner U1 set as destinations or waypoints in the past is displayed on the display device 6.

Similarly, in the first concrete example, the third storage unit 24 has a storage area (referred to as a “first storage area” hereafter) to which the audio control unit 23 refers when a function of disclosing personal information is performed, and another storage area (referred to as a “second storage area” hereafter).

In step ST4, the concealment control unit 26 makes a copy of only the pieces of personal information, out of the pieces of information stored in the first storage area in the third storage unit 24, and causes the second storage area in the third storage unit 24 to store the copy. Then, the concealment control unit 26 deletes only the pieces of personal information, out of the pieces of information stored in the first storage area in the third storage unit 24. As a result, there occurs a state in which the pieces of personal information related to functions performed by the audio control unit 23 are concealed.

A second concrete example is one in which a function of the navigation control unit 22 and the audio control unit 23 for referring to personal information is provided, and a function of the navigation control unit 22 and the audio control unit 23 for disclosing the personal information is disabled when the vehicle user U2 uses the functions.

In the second concrete example, when a signal corresponding to an operation inputted by the operation input device 8 is one showing an instruction to perform a function of disclosing personal information, the concealment control unit 26 outputs an instruction not to output the signal to either the navigation control unit 21 or the audio control unit 23 to the main control unit 27. Further, the concealment control unit 26 outputs an instruction to change the display modes of buttons each for performing a function of disclosing personal information to the main control unit 27.

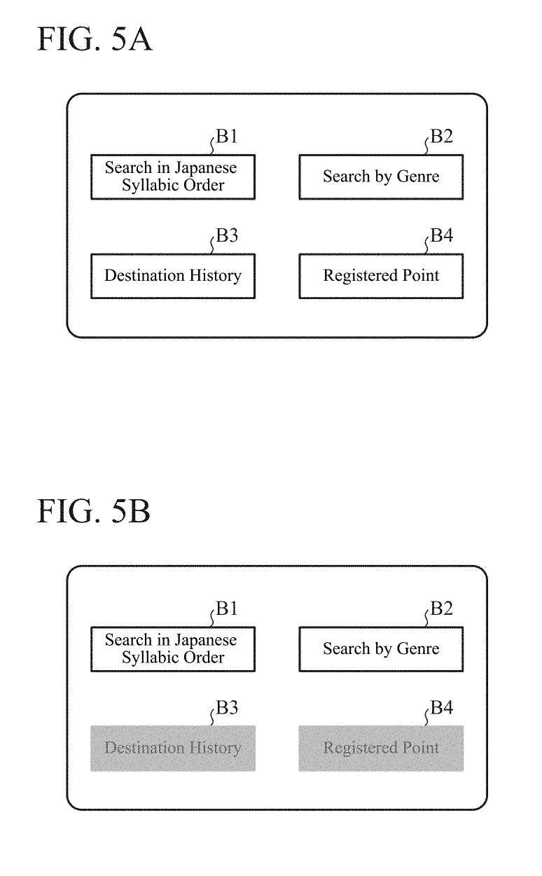

For example, FIG. 5A shows an example of a menu screen that the main control unit 27 causes the display device 6 to display in a state in which the pieces of personal information are not concealed. When a button B1 shown by “Search in Japanese Syllabic Order” in the figure is pushed down through an operation on the operation input device 8, the screen of the display device 6 makes a transition to a screen for searching for facilities on the basis of a name. When a button B2 shown by “Search by Genre” in the figure is pushed down, the screen of the display device 6 makes a transition to a screen for searching for facilities on the basis of a genre. When a button B3 shown by “Destination History” in the figure is pushed down, the screen of the display device 6 makes a transition to a screen for displaying a history of facilities or addresses each of which was set as a destination or a waypoint in the past. When a button B4 shown by “Registered Point” in the figure is pushed down, the screen of the display device 6 makes a transition to a screen for displaying registered points, i.e., the point showing the home of the vehicle owner U1, a point showing a facility in which the vehicle owner U1 is interested, etc.

Here, when the destination history information and the registered point information are set as pieces of personal information, each of the two buttons B3 and B4 in the four buttons B1 to B4 causes a state in which the personal information is disclosed when the corresponding button is pushed down. Therefore, the function of displaying the history of facilities or addresses each of which was set as a destination or a waypoint in the past, and the function of displaying the registered points are targets for the disabling in the process of step ST4.

FIG. 5B shows an example of a menu screen that the main control unit 27 causes the display device 6 to display in the state in which the pieces of personal information are concealed. In step ST4, the concealment control unit 26 instructs the main control unit 27 to display the buttons B3 and B4 for performing the functions that are targets for the disabling in a so-called “grayed out” state. Further, when the operation inputted to the operation input device 8 is one of pushing down either of the buttons B3 and B4, the concealment control unit 26 instructs the main control unit 27 not to output the signal corresponding to the operation to the navigation control unit 21. As a result, there occurs a state in which the function of displaying the history of facilities or addresses each of which was set as a destination or a waypoint in the past, and the function of displaying the registered points are disabled.

Instead of not outputting a signal showing an instruction to perform either of the functions that are targets for the disabling to the navigation control unit 21, and changing instruction of the main control unit 27 to display the buttons B3 and B4 for performing the functions in the grayed out state, the concealment control unit 26 can instruct the main control unit 27 to set these buttons B3 and B4 to non-display.

Further, because an example of disabling a function that the audio control unit 23 has is the same as the example of disabling a function that the navigation control unit 21 has, an illustration and an explanation of the example will be omitted hereafter.

The process of concealing the pieces of personal information is not limited to the above-mentioned concrete examples. As this process, any process can be performed as long as the process causes the state in which the pieces of personal information stored in the storage units 22 and 24 are concealed, i.e., a state in which the disclosure of the pieces of personal information is restricted.

When the current date and time becomes the same as the scheduled rental date and time, i.e., at a time substantially the same as the time that the process of step ST4 is performed, the vehicle 4 is rented out to the vehicle user U2. Because, after step ST4, it is one in which the pieces of personal information are concealed, any personal information about the vehicle owner U1 can be prevented from leaking out when the vehicle 4 is being rented out.

After step ST4, the navigation device 100 starts processing shown in FIG. 4B. First, in step ST5, the concealment control unit 26 acquires the date and time information from, for example, the navigation control unit 21.

Then, in step ST6, the concealment control unit 26 compares the current date and time shown by the date and time information acquired in step ST5 and the scheduled return date and time of the vehicle 4 that is included in the reservation information inputted, in step ST1, from the reservation information acquiring unit 25. The concealment control unit 26 determines whether or not the current date and time is the same as the scheduled return date and time on the basis of the comparison.

When it is determined that the current date and time differs from the scheduled return date and time (“NO” in step ST6), i.e., when the current date and time is earlier than the scheduled return date and time, the concealment control unit 26 returns to the process of step ST5.

In contrast, when it is determined that the current date and time is the same as the scheduled return date and time (“YES” in step ST6), the concealment control unit 26, in step ST7, cancels the concealment of the pieces of personal information stored in the storage units 22 and 24. Hereafter, a concrete example of the process in step ST7 will be explained.

The concealment control unit 26, in step ST7, performs the following process when, instep ST4, performing the process of the above-mentioned first concrete example. More specifically, the concealment control unit 26 makes a copy of the pieces of personal information stored in the second storage area in the second storage unit 22, and causes the first storage area in the second storage unit 22 to store the copy. Then, the concealment control unit 26 can delete the pieces of personal information stored in the second storage area in the second storage unit 22. As a result, there occurs a state in which the concealment of the pieces of personal information related to functions performed by the navigation control unit 21 is canceled.

Similarly, the concealment control unit 26 makes a copy of the pieces of personal information stored in the second storage area in the third storage unit 24, and causes the first storage area in the third storage unit 24 to store the copy. Then, the concealment control unit 26 can delete the pieces of personal information stored in the second storage area in the third storage unit 24. As a result, there occurs a state in which the concealment of the pieces of personal information related to functions performed by the audio control unit 23 is canceled.

As mentioned above, the deletion of the pieces of personal information from the first storage area in step ST4 is a temporary process premised on the recovery in step ST7. The pieces of personal information stored in the second storage area between step ST4 and step ST7 correspond to so-called “backup data.”

The concealment control unit 26, in step ST7, performs the following process when, instep ST4, performing the process of the above-mentioned second concrete example. More specifically, the concealment control unit 26 returns the function placed in the disabled state in step ST4, out of the functions that the navigation control unit 21 and the audio control unit 23 have, to an enabled state.

Concretely, for example, the concealment control unit 26 instructs the main control unit 27 to return the button B3 and B4 that are set to the display of the grayed out state as shown in FIG. 5B to normal display. Further, when the operation inputted to the operation input device 8 is one of pushing down either of the buttons B3 and B4, the concealment control unit 26 instructs the main control unit 27 to output a signal corresponding to the operation to the navigation control unit 21. As an alternative, the concealment control unit 26 instructs the main control unit 27 to cause the button B3 and B4 set to non-display to be displayed. As a result, there occurs a state in which the concealment of the pieces of personal information related to functions that the navigation control unit 21 has is canceled. Further, the concealment control unit 26 outputs a similar instruction for the audio control unit 23 to the main control unit 27. As a result, there occurs a state in which the concealment of the pieces of personal information related to functions that the audio control unit 23 has is canceled.

When the current date and time becomes the same as the scheduled return date and time, i.e., at a time substantially the same as the time that the process of step ST7 is performed, the vehicle 4 is returned to the vehicle owner U1. Because after step ST7, the current state is one in which the concealment of the pieces of personal information is canceled, the vehicle owner U1 can use any function based on personal information about himself or herself as usual when using the navigation device 100 after the vehicle 4 has been returned.

Further, the person-to-person car sharing system 200 of Embodiment 1 does not have to have a recording medium for recording ID information, such as an IC card, which is used in the car sharing system of Patent Literature 1. Therefore, because it is not necessary to add expensive apparatuses such as an IC card reader to each vehicle, the cost of the whole of the person-to-person car sharing system 200 can be reduced, and the economic burden on each user can also be reduced. As a result, the spread of person-to-person car sharing services can be promoted. Further, it is also unnecessary to perform an operation of causing ID information recorded in an IC card to be read by a reader at the time of rental or return of a vehicle, or a like operation. Therefore, such an operation can be prevented from troubling the user.

In the navigation device 100, the audio control unit 23 and the third storage unit 24 which are shown in FIG. 1 can be eliminated.

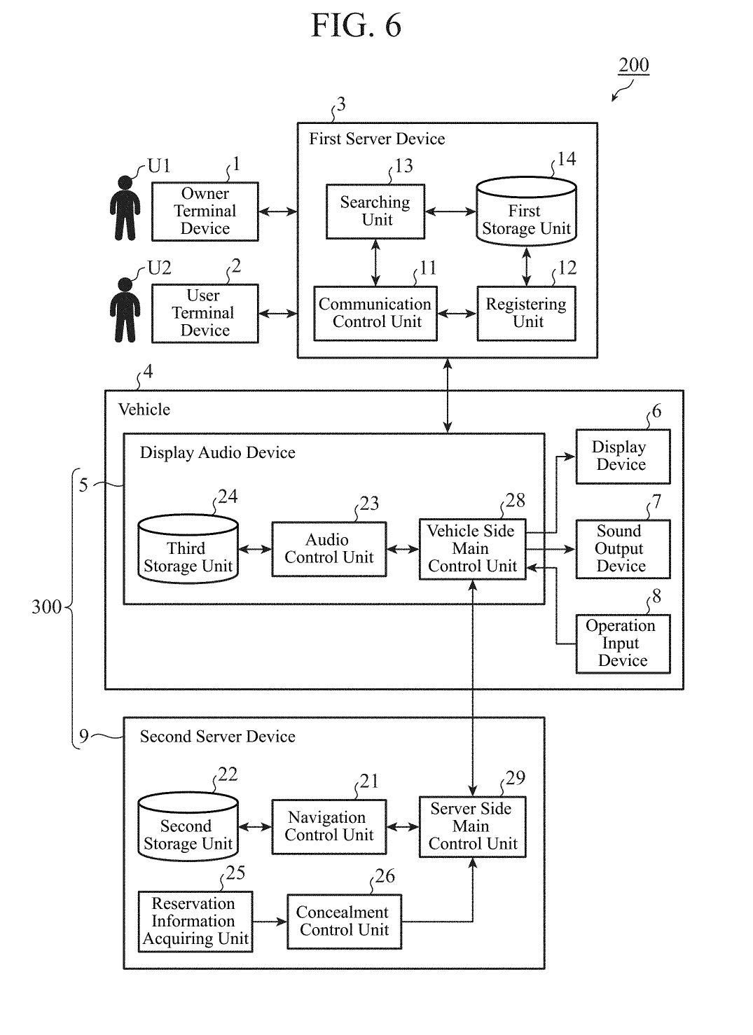

Further, as shown in FIG. 6, the navigation system 300 can be constituted by a display audio device 5 mounted in the vehicle 4, and a second server device 9 that freely communicates with this display audio device 5. In the example shown in FIG. 6, the audio control unit 23 and the third storage unit 24 are provided in the display audio device 5, and the navigation control unit 21, the second storage unit 22, the reservation information acquiring unit 25, and the concealment control unit 26 are provided in the second server device 9. The functions corresponding to the main control unit 27 shown in FIG. 1 are implemented by the cooperation of a vehicle side main control unit 28 provided in the audio control unit 23 and a server side main control unit 29 provided in the second server device 9. The reservation information acquiring unit 25 acquires reservation information directly from the first server device 3 by using communications between the first server device 3 and the second server device 9 (an illustration of a connecting line between the first server device 3 and the second server device 9 in this case is omitted), or acquires reservation information from the first server device 3 via the display audio device 5 by using both communications between the first server device 3 and the display audio device 5, and communications between the display audio device 5 and the second server device 9.

As mentioned above, the navigation device 100 of Embodiment 1 is mounted in the vehicle 4 shared through person-to-person car sharing, and includes: the storage units 22 and 24 for storing pieces of personal information; the reservation information acquiring unit 25 for acquiring a scheduled rental date and time of the vehicle 4 from the first server device 3 that manages the person-to-person car sharing; and the concealment control unit 26 for concealing the pieces of personal information stored in the storage units 22 and 24 when the current date and time becomes the same as the scheduled rental date and time. As a result, any personal information about the vehicle owner U1 can be prevented from leaking out when the vehicle 4 is being rented out, while a state in which the vehicle owner U1 of the vehicle 4 can use a function based on personal information about himself or herself is ensured after the vehicle 4 is returned.

Further, the reservation information acquiring unit 25 acquires a scheduled return date and time of the vehicle 4, and the concealment control unit 26 cancels the concealment of the pieces of personal information when the current date and time becomes the same as the scheduled return date and time. As a result, the vehicle owner U1 can use a function based on personal information about himself or herself after the vehicle 4 is returned.

Further, the concealment control unit 26 conceals the pieces of personal information by disabling a function of referring to personal information and disclosing the personal information at the time of execution. In this case, by performing, for example, the process explained in the above-mentioned second concrete example, any personal information about the vehicle owner U1 can be prevented from leaking out when the vehicle 4 is being rented out, while the state in which the vehicle owner U1 of the vehicle 4 can use a function based on personal information about himself or herself is ensured after the vehicle 4 is returned.

As an alternative, each of the storage units 22 and 24 has the first storage area that is referred to when a function of disclosing personal information is performed, and the second storage area different from the first storage area, and the concealment control unit 26 makes a copy of the pieces of personal information stored in the first storage area and causes the second storage area to store the copy, and also conceals the pieces of personal information by deleting the pieces of personal information stored in the first storage area. In this case, by performing, for example, the process explained in the above-mentioned first concrete example, any personal information about the vehicle owner U1 can be prevented from leaking out when the vehicle 4 is being rented out, while the state in which the vehicle owner U1 of the vehicle 4 can use a function based on personal information about himself or herself is ensured after the vehicle 4 is returned.

As an alternative, the concealment control unit 26 conceals the pieces of personal information by setting an operation button for performing the function of disclosing personal information to non-display. In this case, by performing, for example, the process explained in the above-mentioned second concrete example, any personal information about the vehicle owner U1 can be prevented from leaking out when the vehicle 4 is being rented out, while the state in which the vehicle owner U1 of the vehicle 4 can use a function based on personal information about himself or herself is ensured after the vehicle 4 is returned.

Further, a display control method of Embodiment 1 is one of controlling a display of pieces of personal information on the display device 6 mounted in the vehicle 4 shared through the person-to-person car sharing, and includes: a step (step ST1) of, in the reservation information acquiring unit 25, acquiring a scheduled rental date and time of the vehicle 4 from the first server device 3 that manages the person-to-person car sharing; and steps (steps ST2 to ST4) of, in the concealment control unit 26, concealing the pieces of personal information when the current date and time becomes the same as the scheduled rental date and time. As a result, any personal information about the vehicle owner U1 can be prevented from leaking out when the vehicle 4 is being rented out, while the state in which the vehicle owner U1 of the vehicle 4 can use a function based on personal information about himself or herself is ensured after the vehicle 4 is returned.

### Embodiment 2

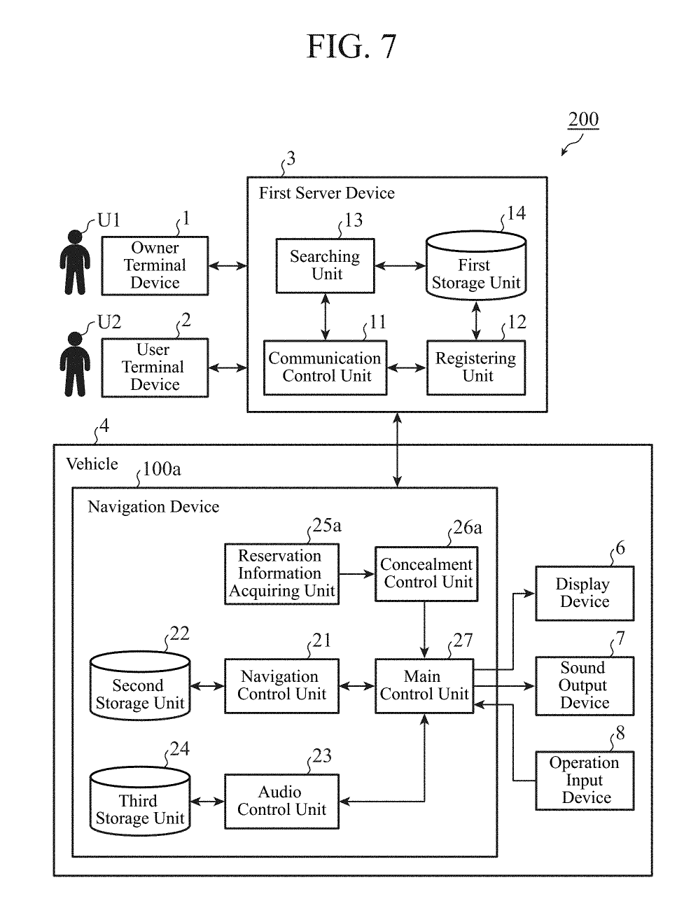

FIG. 7 is a functional block diagram showing a main part of a person-to-person car sharing system including a navigation device according to Embodiment 2 of the present invention. Referring to FIG. 7, the navigation device 100a of Embodiment 2, and the person-to-person car sharing system 200 including this navigation device 100a will be explained.

In FIG. 7, the same blocks as those of the person-to-person car sharing system 200 of Embodiment 1 shown in FIG. 1 are denoted by the same reference character strings, and an explanation of the blocks will be omitted hereafter. Further, because the hardware configuration of a first server device 3 shown in FIG. 7 is the same as that explained in Embodiment 1 by referring to FIG. 2, an illustration and an explanation of the hardware configuration will be omitted hereafter. Because the hardware configuration of the navigation device 100a shown in FIG. 7 is the same as that explained in Embodiment 1 by referring to FIG. 3, an illustration and an explanation of the hardware configuration will be omitted hereafter.

In Embodiment 2, search condition information that a user terminal device 2 transmits to the first server device 3 shows both a rental point and a return point of a vehicle that a vehicle user U2 desires, in addition to a vehicle type of vehicle that the vehicle user U2 desires to use, an area and a date where and when the vehicle user U2 desires to use the vehicle, a scheduled start time of use of the vehicle, and a scheduled end time of use of the vehicle.

In Embodiment 2, a notification showing that there is a rental request to be transmitted to an owner terminal device 1 by the first server device 3 includes the rental point and the return point of the vehicle that the vehicle user U2 desires, in addition to the area and the date where and when the vehicle user U2 desires to use the vehicle, the scheduled start time of use of the vehicle, and the scheduled end time of use of the vehicle.

In Embodiment 2, reservation information that a registering unit 12 causes a first storage unit 14 to store shows both a scheduled rental point and a scheduled return point of a vehicle related to a finalized rental reservation, in addition to both a scheduled rental date and time and a scheduled return date and time of the vehicle. Here, as the scheduled rental point in the reservation information, for example, the same point as the rental point of the vehicle that the vehicle user U2 desires, the rental point being shown by the search condition information, is set up. As the scheduled return point in the reservation information, for example, the same point as the return point of the vehicle that the vehicle user U2 desires, the return point being shown by the search condition information, is set up.

A reservation information acquiring unit 25a acquires the reservation information about the vehicle 4, out of the pieces of reservation information stored in the first storage unit 14 of the first server device 3, by controlling a communication unit of the navigation device 100a. The reservation information acquiring unit 25a outputs the reservation information acquired thereby to a concealment control unit 26a.

The concealment control unit 26a acquires date and time information from, for example, a navigation control unit 21. The concealment control unit 26a determines whether or not the current date and time shown by the date and time information acquired thereby is the same as the scheduled rental date and time of the vehicle 4 shown by the reservation information inputted from the reservation information acquiring unit 25a, by comparing the current date and time and the scheduled rental date and time. When the current date and time becomes the same as the scheduled rental date and time, the concealment control unit 26a conceals the pieces of personal information stored in storage units 22 and 24. Because concrete examples of the process of concealing the pieces of personal information is the same as those of the process performed by the concealment control unit 26 explained in Embodiment 1, an explanation of the examples will be omitted hereafter.

Further, the concealment control unit 26a acquires information (referred to as “position information” hereafter) showing the current position of the vehicle 4 from, for example, the navigation control unit 21. The concealment control unit 26a determines whether or not the current date and time shown by the date and time information acquired thereby exceeds the scheduled return date and time of the vehicle 4 shown by the reservation information inputted from the reservation information acquiring unit 25a by comparing the current date and time and the scheduled return date and time. The concealment control unit 26a determines whether or not the current position shown by the position information acquired thereby is within a predetermined region (referred to as a “reference range” hereafter) from the scheduled return point of the vehicle 4 shown by the reservation information inputted from the reservation information acquiring unit 25a, by comparing the current position and the scheduled return point. When the current date and time exceeds the scheduled return date and time and the current position falls within the reference range from the scheduled return point, the concealment control unit 26a cancels the concealment of the pieces of personal information. Because a concrete example of the process of cancelling the concealment of the pieces of personal information is the same as that of the process performed by the concealment control unit 26 explained in Embodiment 1, an explanation of the example will be omitted hereafter.

As the reference range, for example, a circular range centered at the scheduled return point is set up. It is preferable to set the radius of the circle, i.e., the size of the reference range to an appropriate value in accordance with the accuracy of the position information, or the like.

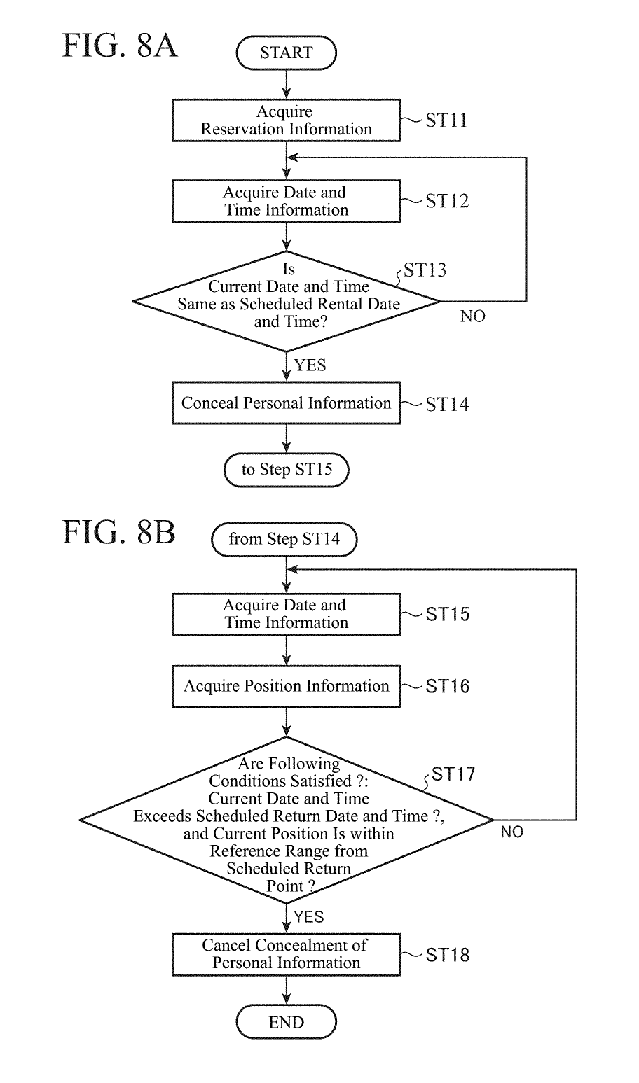

Next, the operation of the navigation device 100a will be explained by referring to flowcharts of FIGS. 8A and 8B, focusing on the process of concealing the pieces of personal information and the process of cancelling the concealment.

First, in step ST11, the reservation information acquiring unit 25a acquires the reservation information about the vehicle 4, out of the pieces of reservation information stored in the first storage unit 14 of the first server device 3, by controlling the communication unit of the navigation device 100a. The reservation information acquiring unit 25a outputs the reservation information acquired thereby to the concealment control unit 26a.

The concealment control unit 26a then performs processes of steps ST12 to ST14. Because the details of the processes of steps ST12 to ST14 are the same as those of the processes of steps ST2 to ST4 shown in FIG. 4A, an explanation of the processes will be omitted hereafter.

Then, in step ST15, the concealment control unit 26a acquires the date and time information from, for example, the navigation control unit 21. Further, in step ST16, the concealment control unit 26a acquires the position information from, for example, the navigation control unit 21.

Then, in step ST17, the concealment control unit 26a compares the current date and time shown by the date and time information acquired in step ST15 and the scheduled return date and time shown by the reservation information inputted, instep ST11, from the reservation information acquiring unit 25a. The concealment control unit 26a determines whether the current date and time exceeds the scheduled return date and time on the basis of the comparison. Further, the concealment control unit 26a compares the current position shown by the position information acquired in step ST16 and the scheduled return point shown by the reservation information inputted, in step ST11, from the reservation information acquiring unit 25a. The concealment control unit 26a determines whether or not the current position is within the reference range from the scheduled return point on the basis of the comparison.

When it is determined that the current date and time is earlier than the scheduled return date and time or the current position is outside the reference range (“NO” in step ST17), the concealment control unit 26a returns to the process of step ST15.

In contrast, when it is determined that the current date and time exceeds the scheduled return date and time and the current position is within the reference range (“YES” in step ST17), the concealment control unit 26a, in step ST18, cancels the concealment of the pieces of personal information stored in the storage units 22 and 24. Because a concrete example of the process of cancelling the concealment of the pieces of personal information is the same as that of the process performed by the concealment control unit 26 explained in Embodiment 1, an explanation of the example will be omitted hereafter.

The navigation device 100 of Embodiment 1 cancels the concealment of the pieces of personal information when the current date and time becomes the same as the scheduled return date and time. Therefore, there is a possibility that there occurs a state in which the concealment of the pieces of personal information is canceled before the vehicle 4 is returned when, for example, the vehicle 4 runs into a traffic jam while the vehicle user U2 uses the vehicle 4, and the return of the vehicle 4 is late with respect to the scheduled return date and time.

In contrast with this, the navigation device 100a of Embodiment 2 cancels the concealment of the pieces of personal information when the current date and time exceeds the scheduled return date and time and the current position falls within the reference range from the scheduled return point. As a result, even when the return of the vehicle 4 is late with respect to the scheduled return date and time, any personal information about the vehicle owner U1 can be prevented more reliably from leaking out.

The concealment control unit 26a, in step ST17, can perform only the process of determining whether or not the current position is within the reference range from the scheduled return point without performing the process of determining whether or not the current date and time exceeds the scheduled return date and time. As a result, even when, for example, the vehicle 4 is returned at a date and time earlier than the scheduled return date and time, the vehicle owner U1 can use a function based on personal information about himself or herself after the return.

However, when, instep ST17, the determination about date and time is not performed, but only the position is set as a determination target, it is desirable, from the viewpoint of preventing any personal information about the vehicle owner U1 more reliably from leaking out, to provide a notification showing that the vehicle 4 will be returned at a date and time earlier than the scheduled return date and time for the vehicle owner U1 of the vehicle 4 before the vehicle 4 is returned. The notification can be provided using, for example, communication functions that pieces of application software for exclusive use installed in the owner terminal device 1 and the user terminal device 2 have.

Further, when, in step ST17, the determination about date and time is not performed, but only the position is set as a determination target, the reservation information can be one not showing the scheduled return date and time. The search condition information can be one not showing the scheduled end date and time of use of the vehicle, and the notification showing that the rental request is made can be one not including the scheduled end date and time of use of the vehicle. The scheduled return date and time can be set up by both the vehicle owner U1 and the vehicle user U2 by using communications between the owner terminal device 1 and the user terminal device 2 via a communication control unit 11, after a rental reservation is finalized.

Further, the reservation information can be one not showing the scheduled rental point. In this case, the search condition information can be one not showing the rental point of the vehicle that the vehicle user U2 desires, and the notification showing that the rental request is made can be one not including the rental point of the vehicle that the vehicle user U2 desires. The scheduled rental point can be set up by both the vehicle owner U1 and the vehicle user U2 by using communications between the owner terminal device 1 and the user terminal device 2 via the communication control unit 11, after a rental reservation is finalized.

In addition, the same various variants as those explained in Embodiment 1 can be applied to the navigation device 100a of Embodiment 2. For example, in the navigation device 100a, an audio control unit 23 and a third storage unit 24 which are shown in FIG. 7 can be eliminated.

As mentioned above, in the navigation device 100a of Embodiment 2, the reservation information acquiring unit 25a acquires reservation information showing both a scheduled return date and time and a scheduled return point of the vehicle 4, and, when the current date and time exceeds the scheduled return date and time and the current position of the vehicle 4 falls within the reference range from the scheduled return point, the concealment control unit 26a cancels the concealment of pieces of personal information. As a result, even when the return of the vehicle 4 is late with respect to the scheduled return time, any personal information about the vehicle owner U1 can be prevented more reliably from leaking out.

It is to be understood that any combination of two or more of the above-mentioned embodiments can be made, various changes can be made in any component according to any one of the above-mentioned embodiments, and any component according to any one of the above-mentioned embodiments can be omitted within the scope of the invention.

### INDUSTRIAL APPLICABILITY

The navigation device of the present invention can be used for guidance of a travel route for a vehicle shared through person-to-person car sharing, and so on.

### REFERENCE SIGNS LIST

1 owner terminal device, 2 user terminal device, 3 first server device, 4 vehicle, 5 display audio device, 6 display device, 7 sound output device, 8 operation input device, 9 second server device, 11 communication control unit, 12 registering unit, 13 searching unit, 14 first storage unit, 21 navigation control unit, 22 second storage unit, 23 audio control unit, 24 third storage unit, 25, 25a reservation information acquiring unit, 26, 26a concealment control unit, 27 main control unit, 28 vehicle side main control unit, 29 server side main control unit, 31 processor, 32 first memory, 33 second memory, 34 processing circuit, 41 processor, 42 first memory, 43 second memory, 44 processing circuit, 100, 100a navigation device, 200 person-to-person car sharing system, and 300 navigation system.

1. A navigation device mounted in a vehicle shared through person-to-person car sharing, comprising:
a processor; and
a memory storing instructions which, when executed by the processor, causes the processor to perform processes of:
storing personal information;
acquiring a scheduled rental date and time of the vehicle from a server device that manages the person-to-person car sharing; and
concealing the personal information stored in the memory when a current date and time becomes identical to the scheduled rental date and time.

2. The navigation device according to claim 1,
wherein the processor acquires a scheduled return date and time of the vehicle, and
cancels the concealment of the personal information when the current date and time becomes identical to the scheduled return date and time.

3. The navigation device according to claim 1,
wherein the processor acquires both a scheduled return date and time and a scheduled return point of the vehicle, and
cancels the concealment of the personal information when the current date and time exceeds the scheduled return date and time and a current position of the vehicle falls within a reference range from the scheduled return point.

4. The navigation device according to claim 1,
wherein the processor conceals the personal information by disabling a function of referring to the personal information and disclosing the personal information when the function is performed.

5. The navigation device according to claim 1,
wherein the memory has a first storage area that is referred to when a function of disclosing the personal information is performed, and a second storage area different from the first storage area, and
the processor conceals the personal information by making a copy of the personal information stored in the first storage area and causing the second storage area to store the copy, and deleting the personal information stored in the first storage area.

6. The navigation device according to claim 1,
wherein the processor conceals the personal information by setting an operation button for performing a function of disclosing the personal information to non-display.

7. A display control method of controlling a display of personal information on a display device mounted in a vehicle shared through person-to-person car sharing, comprising:
acquiring a scheduled rental date and time of the vehicle from a server device that manages the person-to-person car sharing; and
concealing the personal information when a current date and time becomes identical to the scheduled rental date and time.
